(19) United States
(12) Patent Application Publication
(10) Pub. No.: US 2015/0378280 A1
(43) Pub. Date: Dec. 31, 2015

(54) Devices and Methods for Remanufacturing Printer Cartridges

(71) Applicant: Mitsubishi Kagaku Imaging Corporation, Glendale, CA (US)

(72) Inventors: Denny Holmes, Los Angeles, CA (US); Tigran Ohanyan, Van Nuys, CA (US)

(21) Appl. No.: 14/754,089

(22) Filed: Jun. 29, 2015

Related U.S. Application Data
(60) Provisional application No. 61/998,431, filed on Jun. 28, 2014.

(51) Int. Cl. B23B 51/08; G03G 15/00

(52) U.S. Cl. CPC G03G 15/0894; B23B 51/08

(57) ABSTRACT

The disclosure relates to devices and methods for remanufacturing printer cartridges by forming toner fill openings in the printer cartridges.

### CROSS REFERENCE TO RELATED APPLICATIONS

This application claims the benefit of U.S. Provisional Patent Application Ser. No. 61/998,431, filed Jun. 28, 2014, which is incorporated herein by reference in its entirety.

### BACKGROUND

1. Field of the Invention

The invention relates to devices and methods for remanufacturing printer cartridges, and in particular, to devices and methods for remanufacturing printer cartridges by forming toner fill openings in the printer cartridges.

2. Background Art

Printer cartridges, such as toner cartridges, are used in various electrophotographic imaging devices, such as laser printers, copiers, facsimile machines, and multifunction imaging devices. Once original equipment manufacturer (OEM) printer cartridges are used, they are often recycled and remanufactured. The process of remanufacturing a printer cartridge may include cleaning the cartridge, repairing damaged parts, replacing worn parts, reassembling with new parts, and replenishing the cartridge with toner. The process of remanufacturing a printer cartridge requires that the printer cartridge be disassembled so that access to the various parts can be achieved, and further requires that the printer cartridge be reassembled for subsequent use.

Printer cartridges, such as toner cartridges, typically include toner hoppers that contain toner. It is desirable to have a toner fill opening in order to fill the toner hopper with toner. However, certain printer cartridges may not have toner fill openings, and toner fill openings must be made or formed in the toner cartridge, such as via cutting or drilling. Moreover, certain printer cartridges may have an existing toner fill opening that is located in an inaccessible location during remanufacturing or that is not usable during remanufacturing of the toner cartridge due to location on the cartridge. Known hand tools, such as drills, knives, screwdrivers, and cutting tools, are typically used to cut a toner fill opening in a toner cartridge. However, if not used carefully and properly, such known hand tools can damage the toner hopper and/or other printer cartridge components. In particular, damage to the toner hopper may affect or prevent its reuse.

It is thus desirable to be able to form a toner fill opening in a toner cartridge without damage to the toner hopper and/or other printer cartridge components. This helps preserve the appearance of the printer cartridge and minimizes remanufacturing steps. Devices and methods for efficiently and quickly removing and replacing an organic photoconductor (“OPC”) drum from a printer cartridge are desired.

Accordingly, there is a need for an improved device and method for remanufacturing printer cartridges that overcomes the issues associated with known devices and methods.

### SUMMARY

This need for an improved device and method for remanufacturing printer cartridges is satisfied.

There is provided in one embodiment a printer cartridge cutting and removal device for use in cutting an opening in a printer cartridge. The printer cartridge cutting and removal device comprises an elongated shaft; a first cutting member attached to a first end of the elongated shaft; a collar member attached to a second end of the elongated shaft; a sleeve member having a threaded opening configured for attachment with a threaded portion on the first end of the elongate shaft; and, a pair of second cutting members attached to a first end of the sleeve member. The first cutting member and the second cutting members are configured to cut the opening comprising a toner fill opening in the printer cartridge.

There is provided in another embodiment a method for remanufacturing a printer cartridge having a toner hopper configured to store toner. The method comprises the step of cutting a first opening in a printer cartridge with a first cutting member of a printer cartridge cutting and removal device. The method further comprises the step of cutting a pair of second openings in the printer cartridge with a pair of second cutting members of the printer cartridge cutting and removal device, the first opening being positioned in between the pair of second openings, and obtaining a cut-out portion attached to the pair of second cutting members. The method further comprises the step of removing the cut-out portion from the printer cartridge with the printer cartridge cutting and removal device.

The above description sets forth, rather broadly, a summary of the disclosed embodiments so that the detailed description that follows may be better understood and contributions of the invention to the art may be better appreciated. Some of the disclosed embodiments may not include all of the features or characteristics listed in the above summary. There may be, of course, other features of the disclosed embodiments that will be described below and may form the subject matter of claims. The features, functions, and advantages that have been discussed can be achieved independently in various embodiments of the disclosure or may be combined in yet other embodiments further details of which can be seen with reference to the following description and drawings.

### DESCRIPTION OF DRAWINGS

The invention can be better understood with reference to the following detailed description taken in conjunction with the accompanying drawings which illustrate preferred and exemplary embodiments, but which are not necessarily drawn to scale, wherein:

FIG. 1A shows an exploded perspective view of one of the embodiments of a printer cartridge cutting and removal device of the disclosure;

FIG. 1B shows a cross-sectional perspective view of the assembled printer cartridge cutting and removal device of FIG. 1A in a first position;

FIG. 1C shows the cross-sectional perspective view of the assembled printer cartridge cutting and removal device of FIG. 1B in a second position;

FIGS. 2A-2G show front sectional views of one of the embodiments of the printer cartridge cutting and removal device of the disclosure in use positions during cutting and removal of a toner fill opening in a toner hopper;

FIG. 3 shows a cross-sectional front view of another embodiment of the printer cartridge cutting and removal device of the disclosure;

FIG. 4 is a front side perspective view of a sleeve member of the printer cartridge cutting and removal device of FIG. 1A;

FIG. 5A shows an exploded perspective view of the embodiment of the printer cartridge cutting and removal device of FIG. 3;

FIG. 5B shows an assembled perspective view of the printer cartridge cutting and removal device of FIG. 5A in a first position;

FIG. 5C shows the printer cartridge cutting and removal device of FIG. 5B in a second position;

FIG. 5D shows a side view of the printer cartridge cutting and removal device of FIG. 5C in the second position;

FIG. 6A shows a cross-sectional perspective view of the assembled printer cartridge cutting and removal device of FIG. 5B in the first position;

FIG. 6B shows a cross-sectional perspective view of the assembled printer cartridge cutting and removal device of FIG. 6A in the second position;

FIGS. 7A-7D show front views of the printer cartridge cutting and removal device of FIG. 5B in use positions during cutting and removal of a toner fill opening in a toner hopper;

FIG. 8 a flow diagram of one of the embodiments of a method for remanufacturing a printer cartridge using one of the embodiments of a printer cartridge cutting and removal device of the disclosure; and

FIG. 9 is a perspective view of a printer cartridge for which the printer cartridge cutting and removal device of the disclosure may be used with or applied.

### DETAILED DESCRIPTION

Disclosed embodiments will now be described more fully hereinafter with reference to the accompanying drawings, in which some, but not all disclosed embodiments are shown. Indeed, several different embodiments may be provided and should not be construed as limited to the embodiments set forth herein. Rather, these embodiments are provided so that this disclosure will be thorough and complete and will fully convey the scope of the disclosure to those skilled in the art. It is to be understood that other embodiments may be utilized and structural changes may be made without departing from the scope of the invention. Also, it is to be understood that the phraseology and terminology employed herein are for the purpose of description and should not be regarded as limiting.

The order in which the steps are presented below is not limited to any particular order and does not necessarily imply that they have to be performed in the order presented. It will be understood by those of ordinary skill in the art that the order of these steps can be rearranged and performed in any suitable manner. It will further be understood by those of ordinary skill in the art that some steps may be omitted or added and still fall within the spirit of the invention.

The disclosed embodiments provide various devices and methods for remanufacturing printer cartridges, such as toner cartridges, and in particular, for removing and replacing an OPC drum in a printer cartridge and installing a replacement OPC drum in a printer cartridge. The disclosed embodiments of the devices and methods may be used with printer cartridges that can be used in various laser printer models.

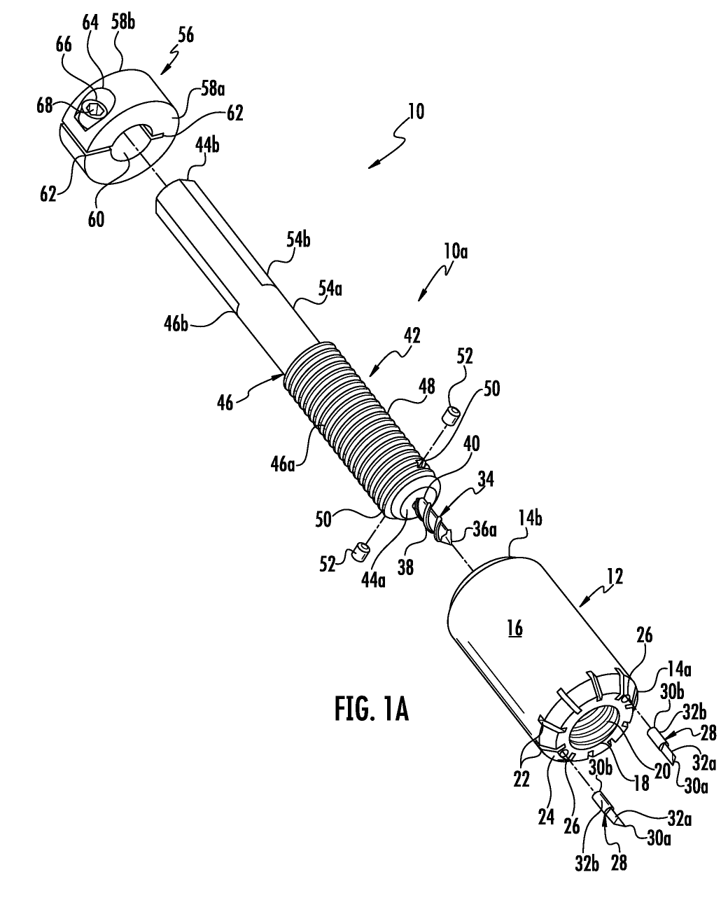

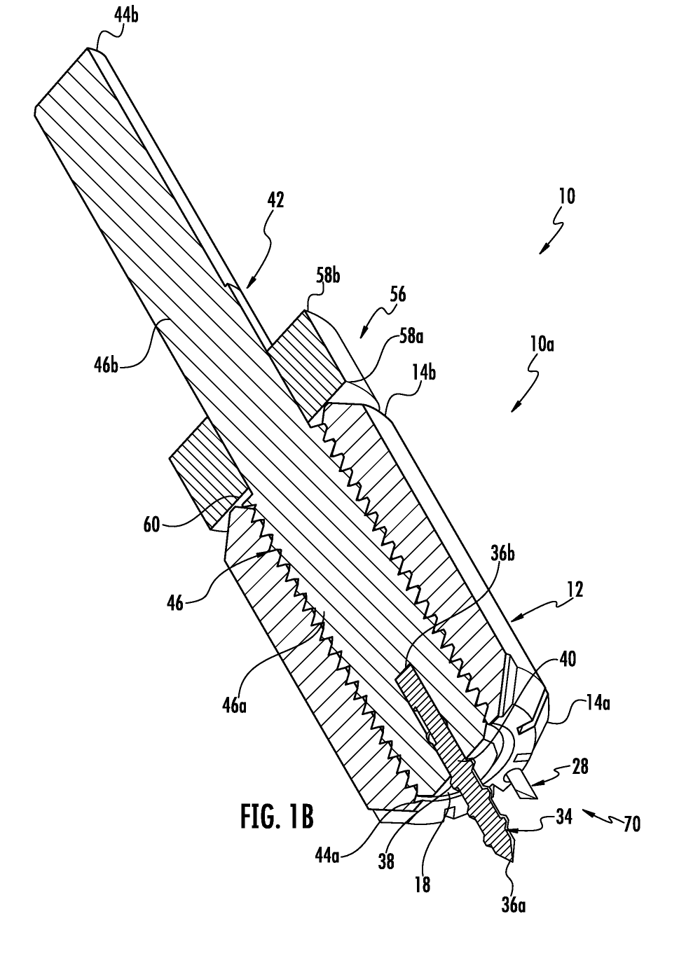

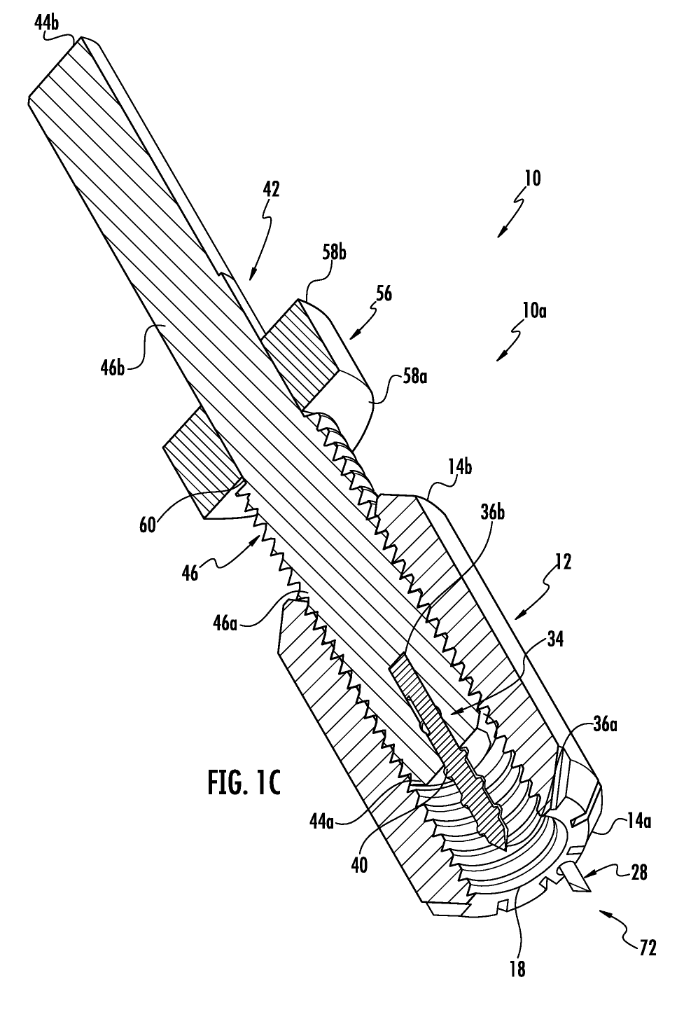

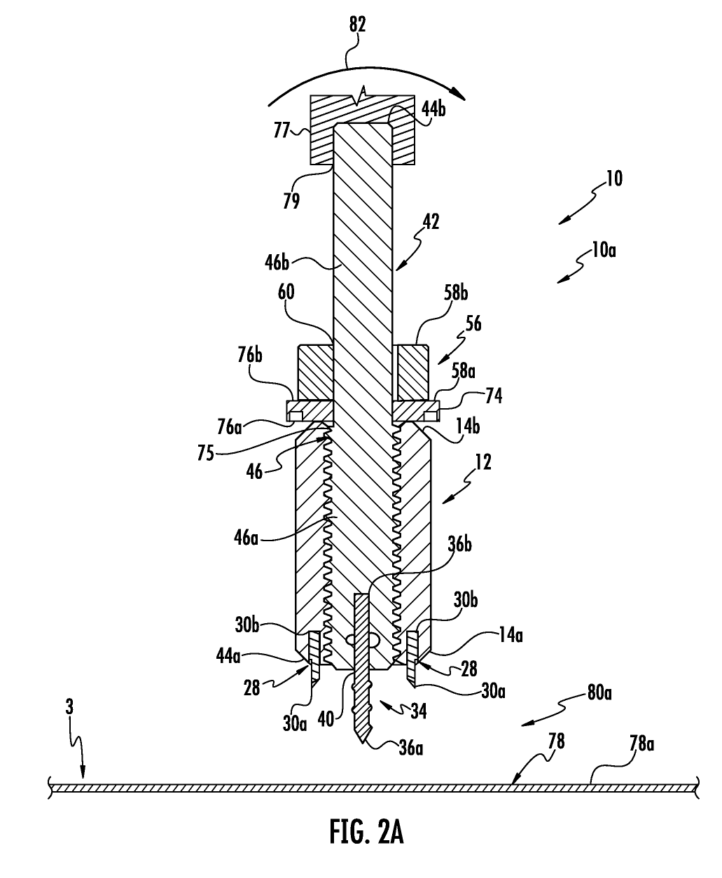

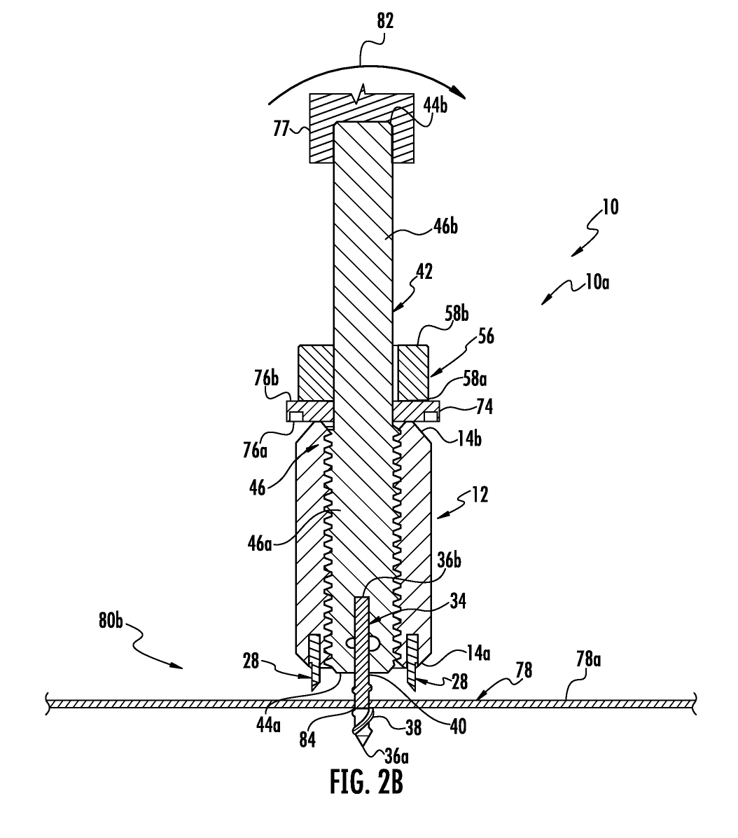

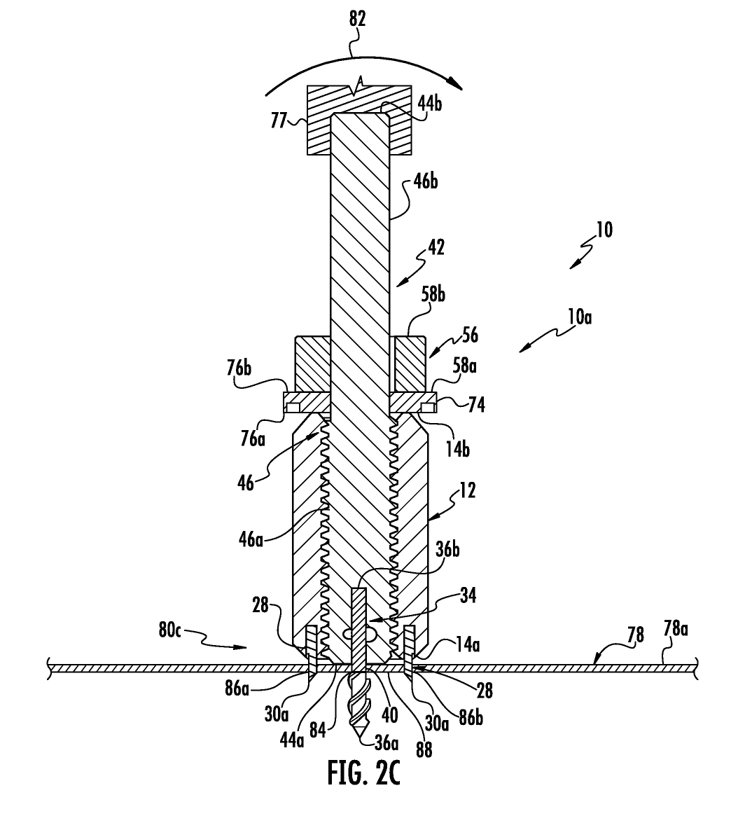

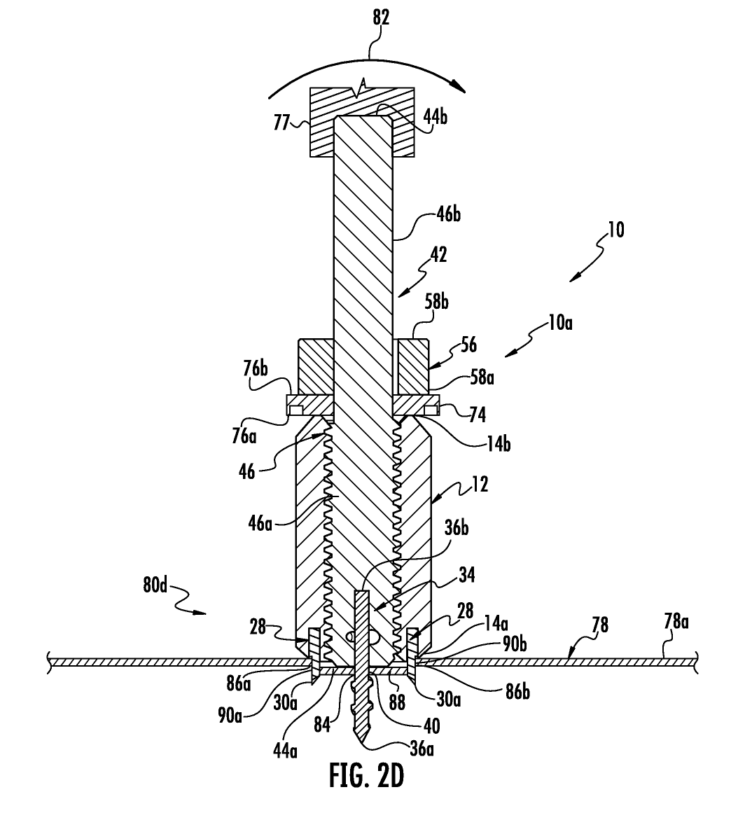

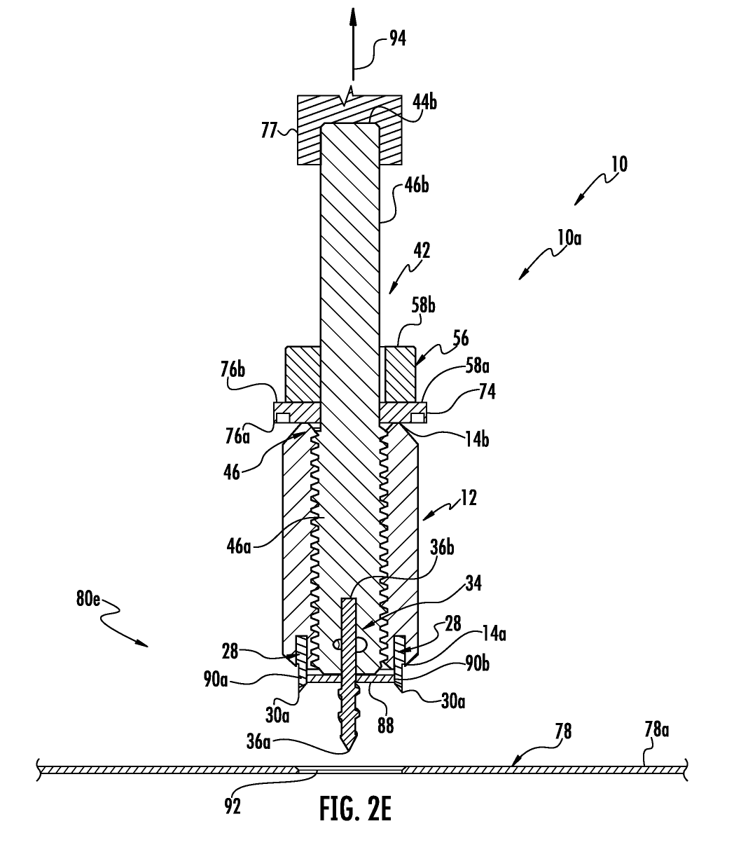

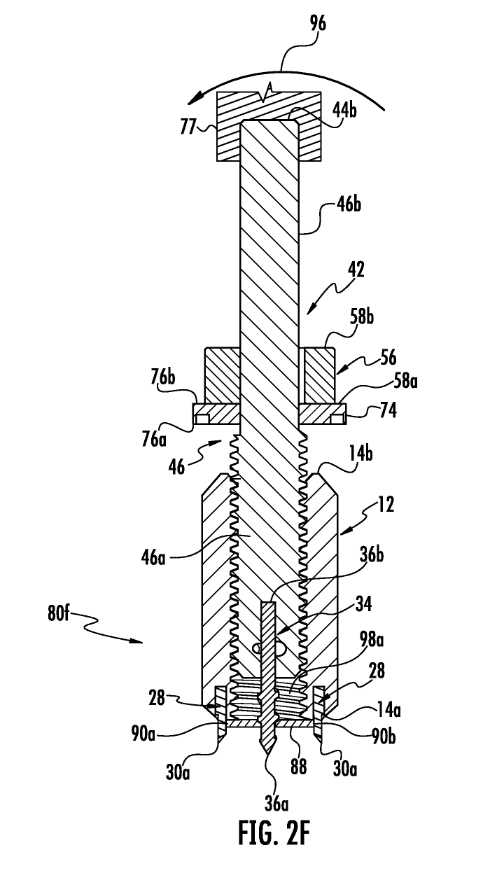

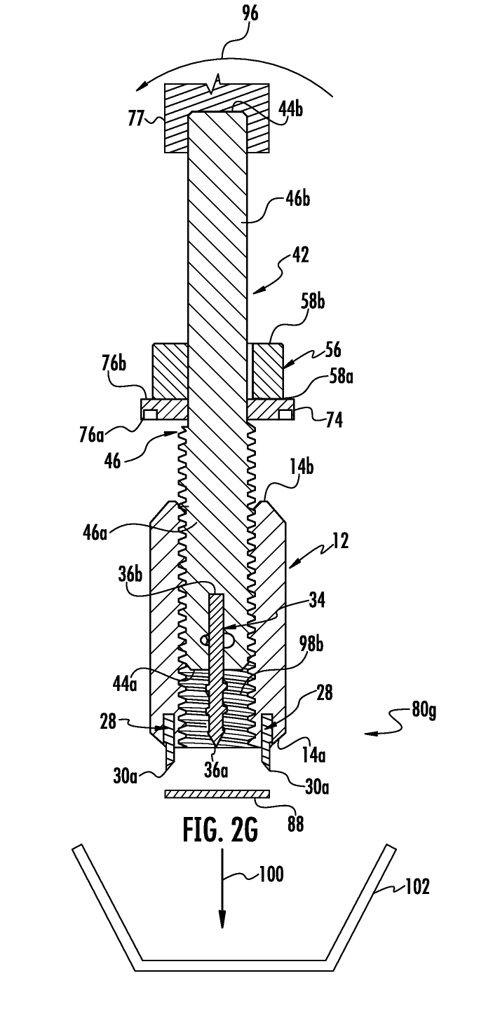

Referring to the Figures, FIG. 1A shows an exploded perspective view of one of the embodiments of a printer cartridge cutting and removal device 10, such as in the form of printer cartridge cutting and removal device 10a, of the disclosure. As shown in FIG. 1A, there is provided in one embodiment a printer cartridge cutting and removal device 10 for use in cutting an opening in a printer cartridge 1. As shown in FIG. 1A, the printer cartridge cutting and removal device 10 comprises an elongated shaft 42; a first cutting member 34 attached to a first end 44a of the elongated shaft 42; a collar member 56 attached to a second end 44b of the elongated shaft 42; a sleeve member 12 having a threaded opening 18 configured for attachment with a threaded portion 46a on the first end 44a of the elongated shaft 42; and, a pair of second cutting members 28 attached to a first end 14a of the sleeve member 12. The first cutting member 34 and the second cutting members 28 are configured to cut the opening comprising a toner fill opening 92 (see FIG. 2E) or toner fill opening 5 in the printer cartridge 1. In this embodiment, the collar member 56 (see FIG. 1A) preferably has a first end 58a, a second end 58b, a collar opening 60, side slots 62, drill attachment portion 64, drill attachment element 66, and opening 68.

FIG. 1B shows a cross-sectional perspective view of the assembled printer cartridge cutting and removal device 10, such as in the form of printer cartridge cutting and removal device 10a of FIG. 1A in a first position 70. FIG. 1C shows the cross-sectional perspective view of the assembled printer cartridge cutting and removal device 10, such as in the form of printer cartridge cutting and removal device 10a, of FIG. 1B in a second position 72.

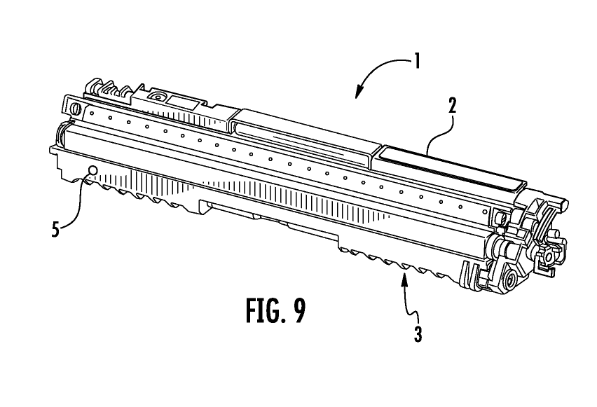

FIGS. 2A-2G show front sectional views of one of the embodiments of the printer cartridge cutting and removal device 10, such as in the form of printer cartridge cutting and removal device 10a, of the disclosure in use positions 80a-80g, respectively, during cutting and removal of a toner fill opening 92 (see FIG. 2E) in a toner hopper 3 (see FIG. 9). FIG. 2A shows a pre-cutting position 80a of the printer cartridge cutting and removal device 10a. FIG. 2B shows an initial cutting position 80b of the printer cartridge cutting and removal device 10a. FIG. 2C shows a full cutting position 80c of the printer cartridge cutting and removal device 10a. FIG. 2D shows a chamfering/cleaning position 80d of the printer cartridge cutting and removal device 10a. FIG. 2E shows a full removal position 80e of the printer cartridge cutting and removal device 10a. FIG. 2F shows a partial release position 80f of the printer cartridge cutting and removal device 10a. FIG. 2G shows a full release position 80g of the printer cartridge cutting and removal device 10a. FIG. 2A shows a first rotational direction 82 of the printer cartridge cutting and removal device 10a. FIG. 2E shows an upward direction 94 of the printer cartridge cutting and removal device 10a. FIGS. 2F and 2G show a second rotational direction 96 of the printer cartridge cutting and removal device 10a. FIG. 2G shows a downward direction 100 of the printer cartridge cutting and removal device 10a.

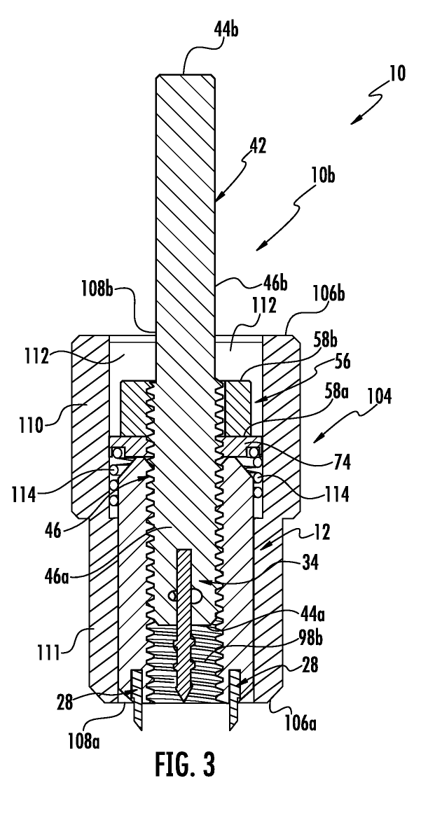

FIG. 3 shows a cross-sectional front view of another embodiment of the printer cartridge cutting and removal device 10, such as in the form of printer cartridge cutting and removal device 10b, of the disclosure.

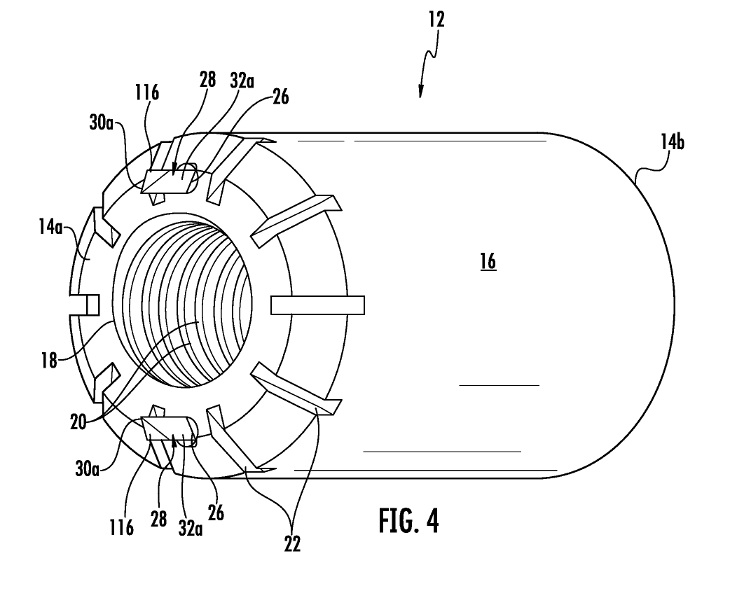

FIG. 4 is a front side perspective view of a sleeve member 12 of the printer cartridge cutting and removal device 10 of FIG. 1A. As shown in FIG. 4, the sleeve member 12 comprises a first end 14a, a second end 14b, a cylindrical body 16, a threaded opening 18, threads 20, slotted portions 22, an angled rim portion 24, and second cutting member openings 26. As further shown in FIG. 4, the second cutting members 28 each have a first end 30a, a second end 30b, angled cutting teeth 32b, and an angled face 116.

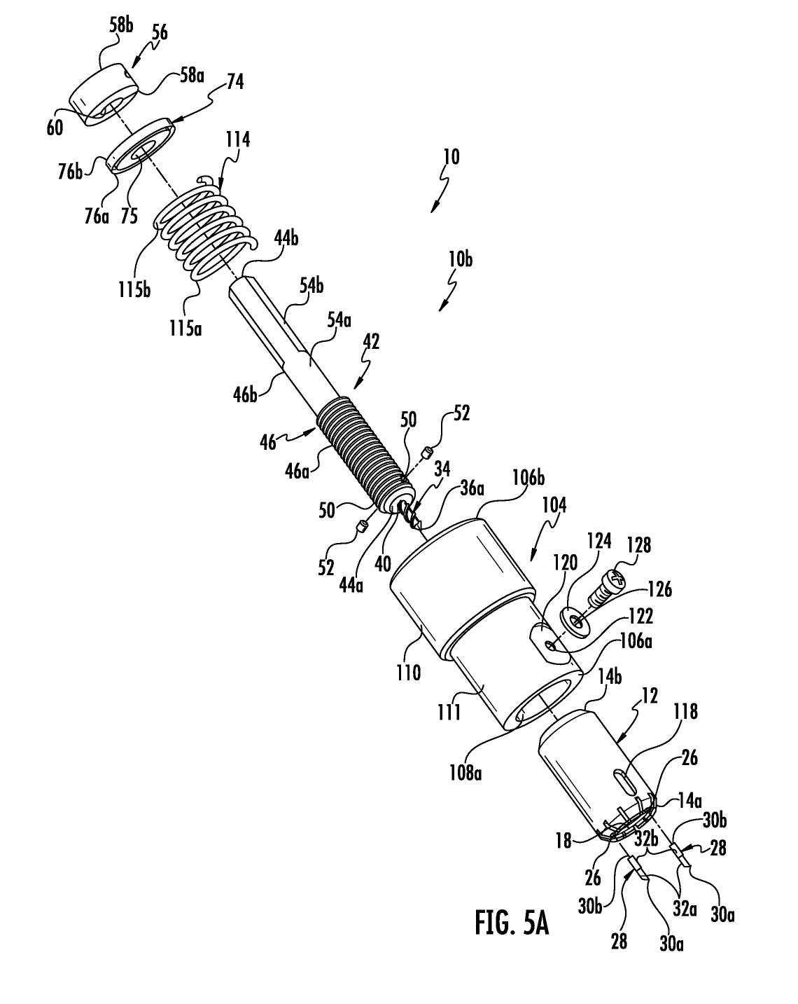

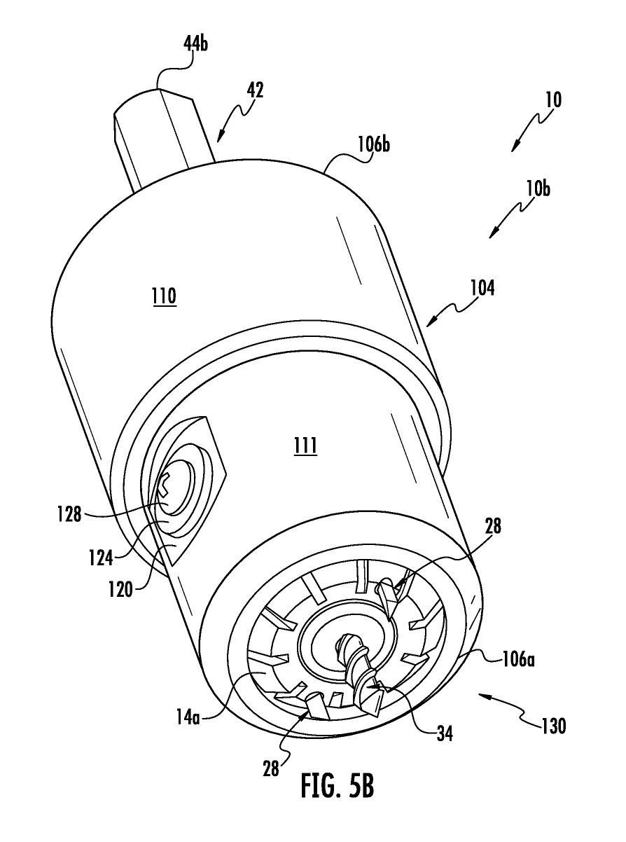

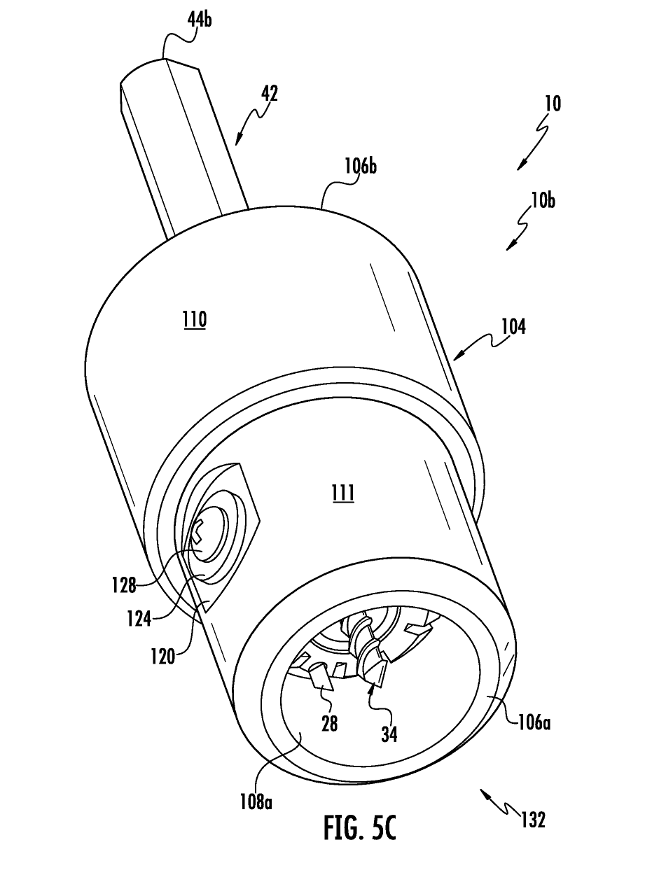

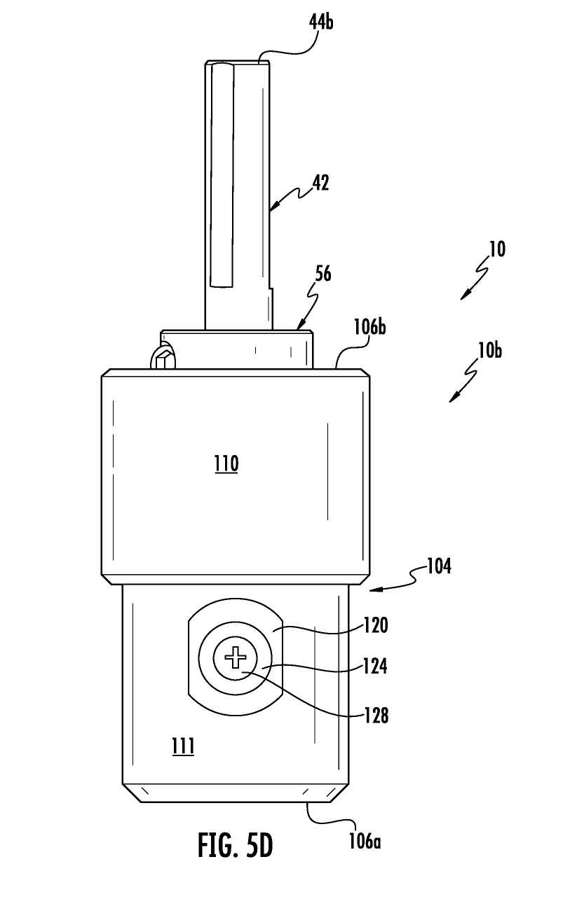

FIG. 5A shows an exploded perspective view of the embodiment of the printer cartridge cutting and removal device 10, such as in the form of printer cartridge cutting and removal device 10b, of FIG. 3. As shown in FIG. 5A, the printer cartridge cutting and removal device 10 may further comprise a guard member 104 having a first end 106a and a second end 106b, a first end opening 108a, a second end opening 108b, a first body portion 110, a second body portion 111, and an interior spaced portion 112. The printer cartridge cutting and removal device 10 may further comprise a spring element 114 having a first end 115a and a second end 115b. The printer cartridge cutting and removal device 10 may further comprise a spring support element 74 having a central opening 75, a first end 76a, and a second end 76b. The printer cartridge cutting and removal device 10 may further comprise collar member 56 having a first end 58a, a second end 58b, and a collar opening 60.

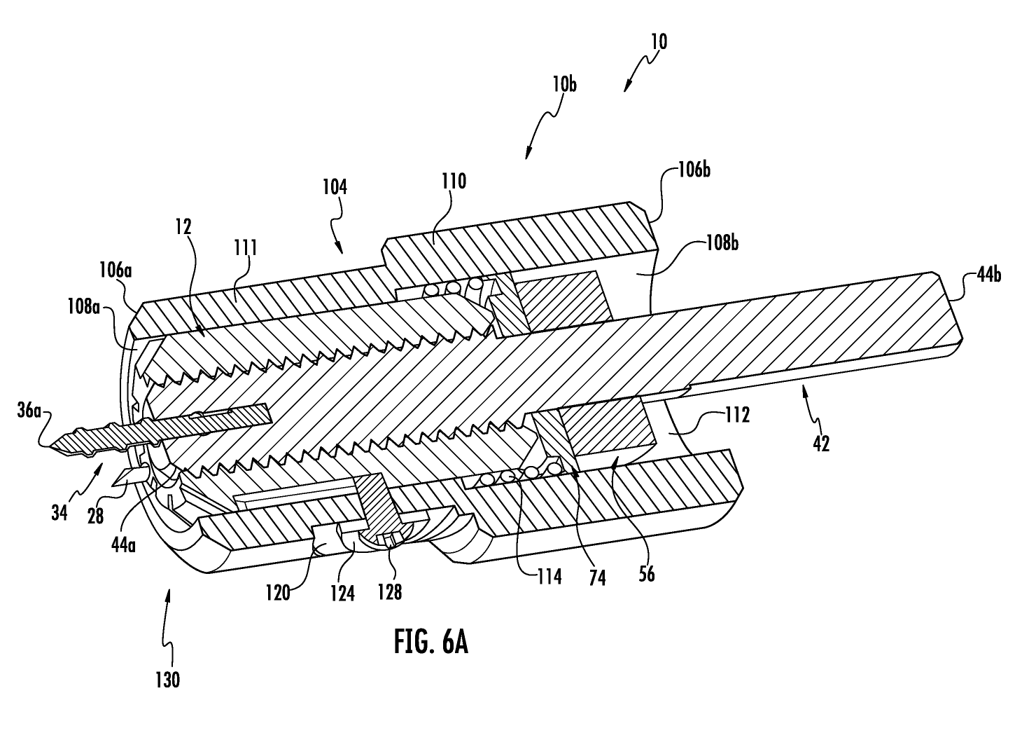

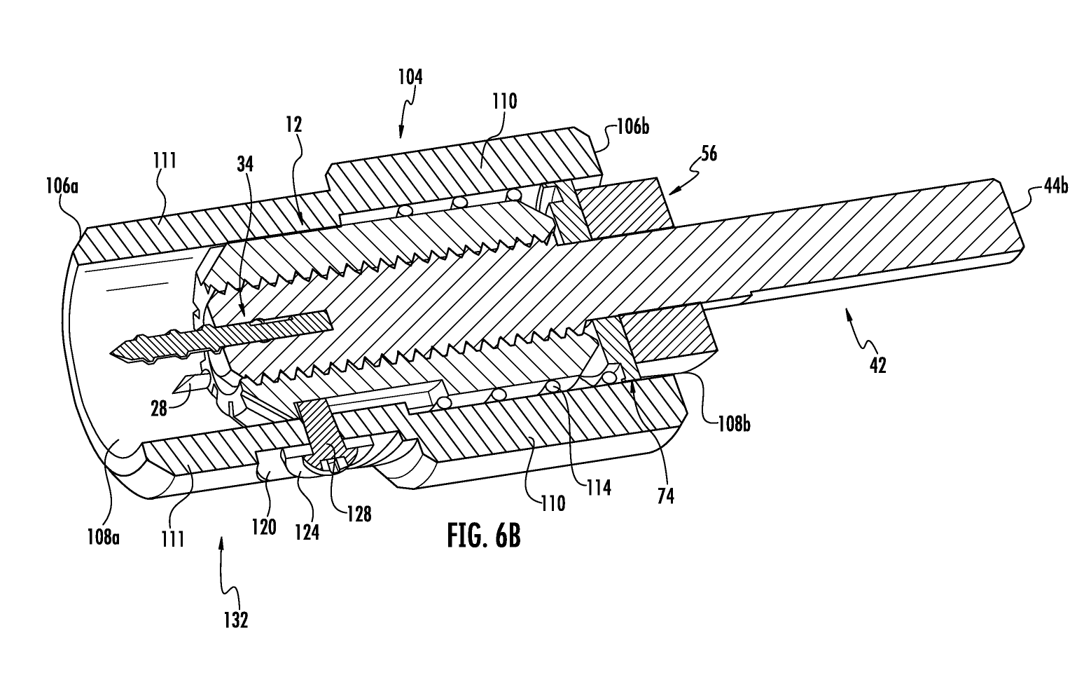

FIG. 5B shows an assembled perspective view of the printer cartridge cutting and removal device 10, such as in the form of printer cartridge cutting and removal device 10b, of FIG. 5A in a first position 130. FIG. 5C shows the printer cartridge cutting and removal device 10, such as in the form of printer cartridge cutting and removal device 10b, of FIG. 5B in a second position 132. FIG. 5D shows a side view of the printer cartridge cutting and removal device 10, such as in the form of printer cartridge cutting and removal device 10b, of FIG. 5C in the second position 132. FIGS. 5B and 6A show a first position 130. FIGS. 5C and 6B show a second position 132.

FIG. 6A shows a cross-sectional perspective view of the assembled printer cartridge cutting and removal device 10, such as in the form of printer cartridge cutting and removal device 10b, of FIG. 5B in the first position 130. FIG. 6B shows a cross-sectional perspective view of the assembled printer cartridge cutting and removal device 10, such as in the form of printer cartridge cutting and removal device 10b, of FIG. 6A in the second position 132.

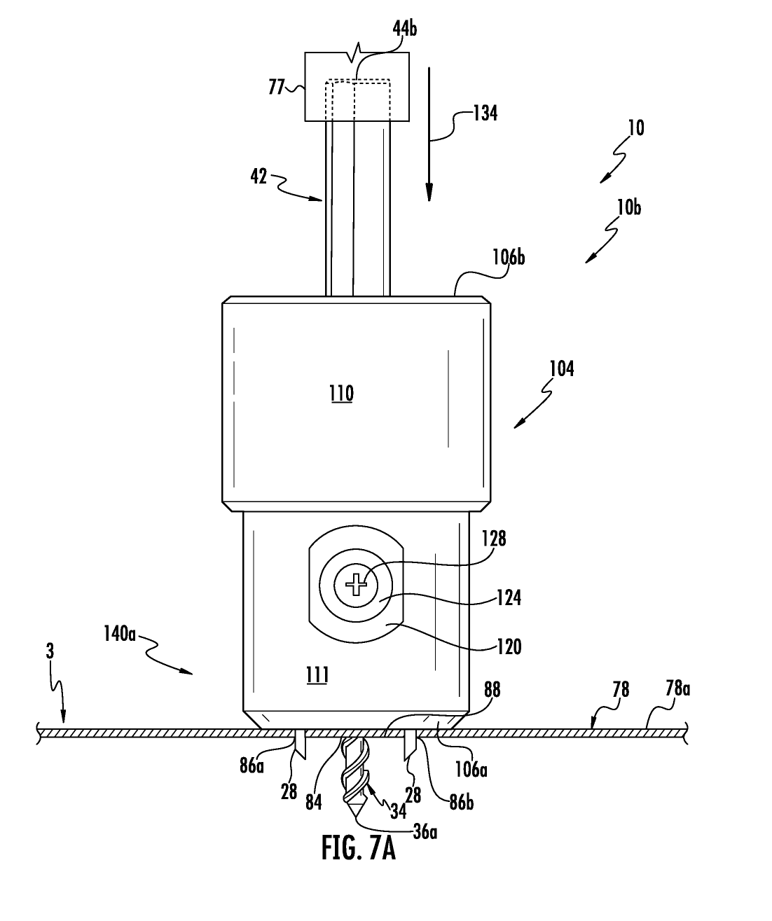

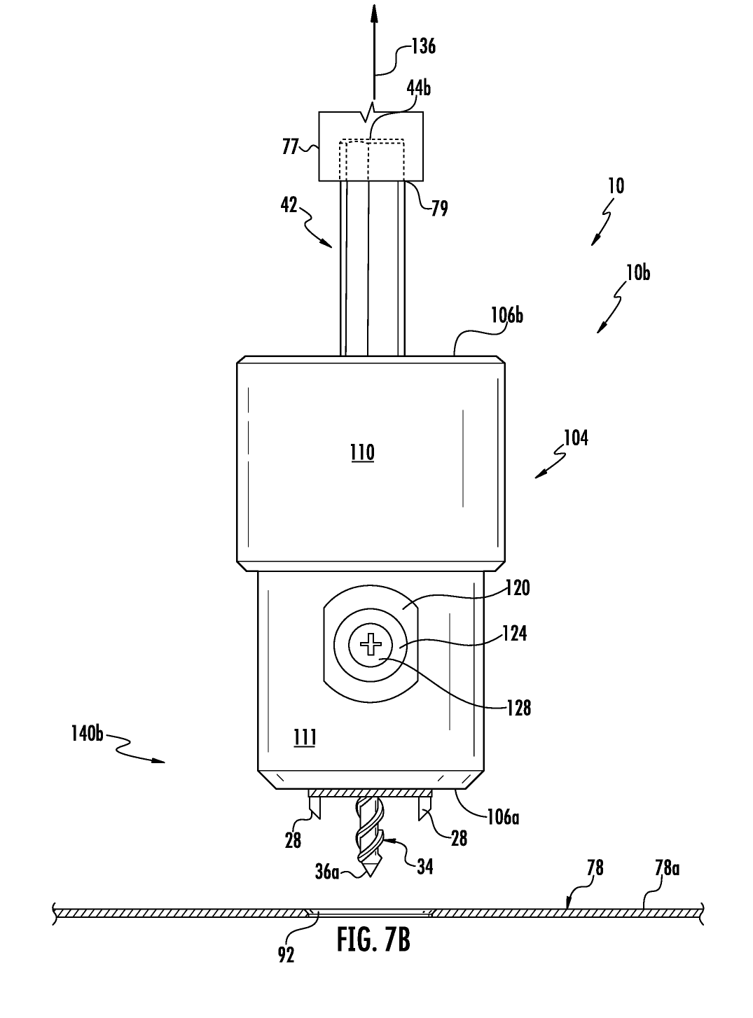

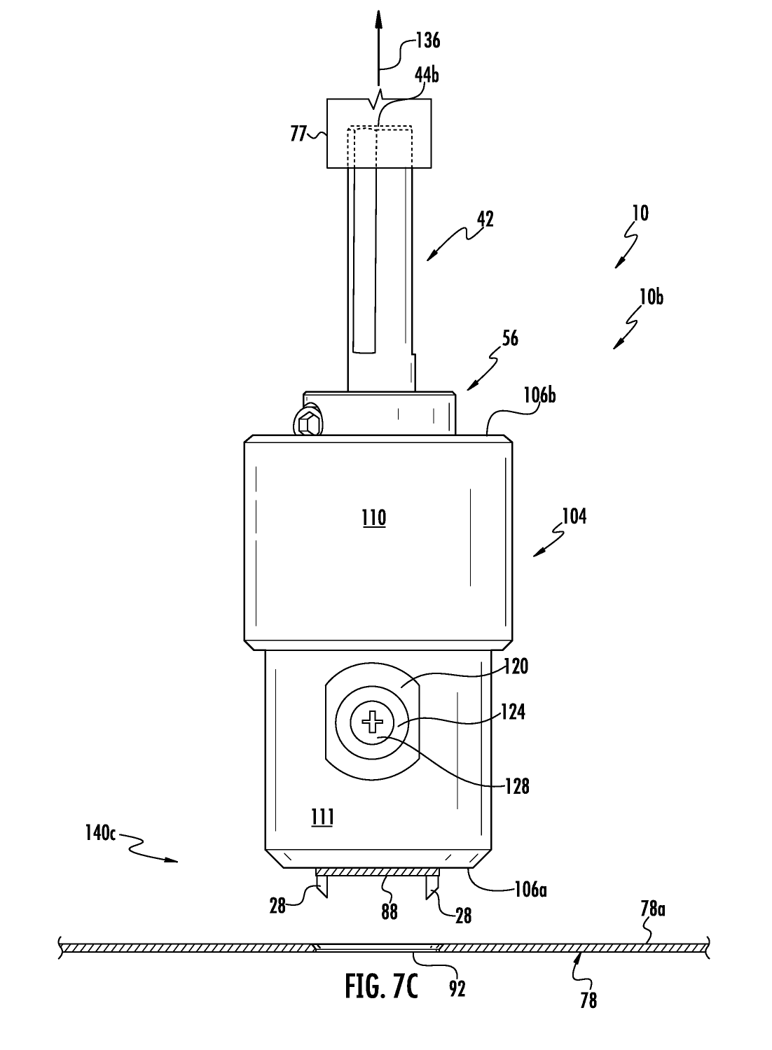

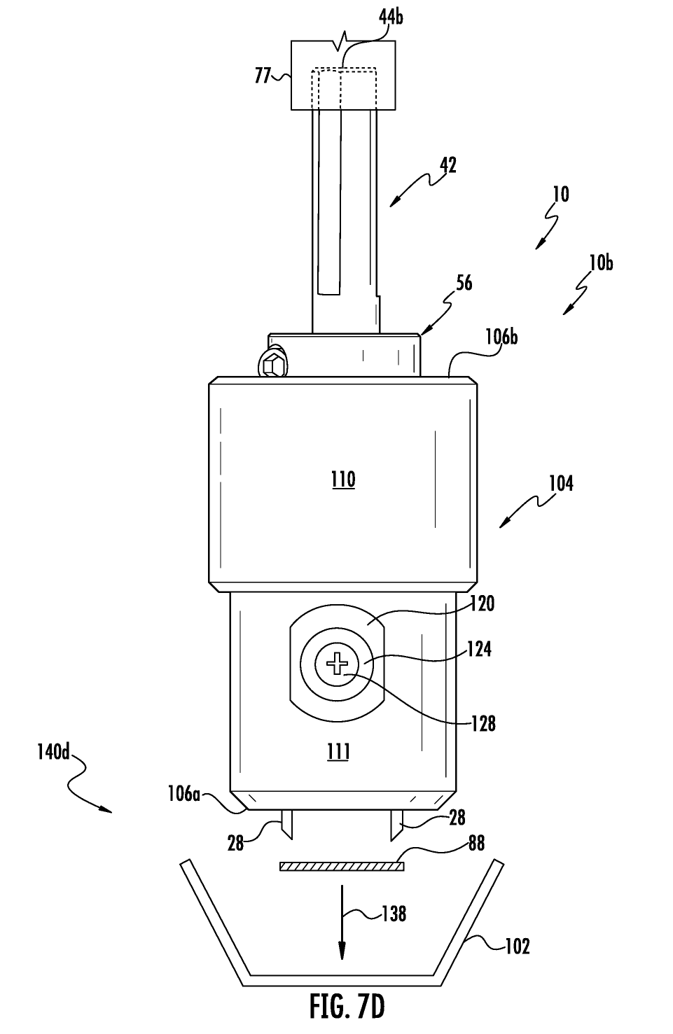

FIGS. 7A-7D show front views of the printer cartridge cutting and removal device 10, such as in the form of printer cartridge cutting and removal device 10b, of FIG. 5B in use positions 140a-140d, respectively, during cutting and removal of a toner fill opening 5 (see FIG. 9) in a toner hopper 3 (see FIG. 9). FIG. 7A shows a full cutting position 140a of the printer cartridge cutting and removal device 10a. FIG. 7B shows a full removal position 140b of the printer cartridge cutting and removal device 10a. FIG. 7C shows a partial release position 140c of the printer cartridge cutting and removal device 10a. FIG. 7D shows a full release position 140d of the printer cartridge cutting and removal device 10a. FIG. 7A shows a downward position 134. FIG. 7B shows an upward position 136. FIG. 7C shows an upward position 136. FIG. 7D shows a downward position 138.

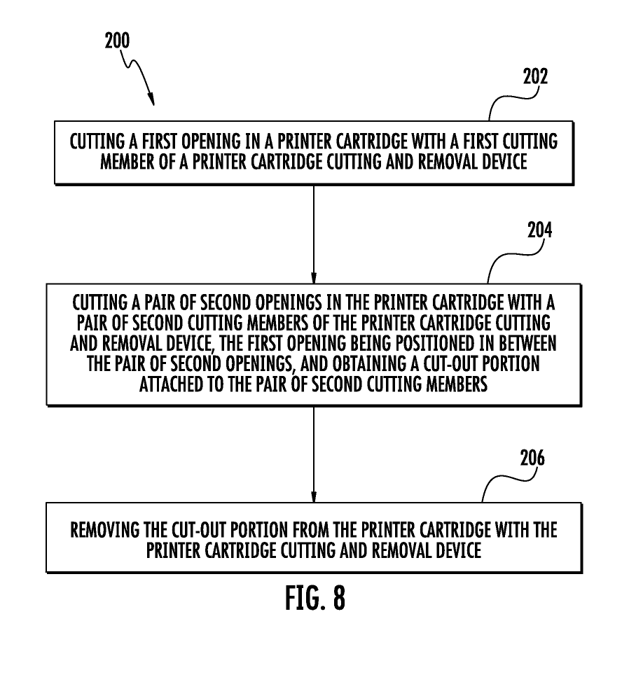

FIG. 8 is a flow diagram of one of the embodiments of a method 200 for remanufacturing a printer cartridge 1 (see FIG. 9) having a toner hopper 3 (see FIG. 9) configured to store toner, using one of the embodiments of a printer cartridge cutting and removal device 10 (see FIGS. 1A, 5A) of the disclosure. As shown in FIG. 8, the method 200 comprises step 202 of cutting a first opening 84 (see FIG. 2B) in a toner hopper surface 78 (see FIG. 2B) of a toner hopper 3 (see FIG. 9) of the printer cartridge 1 (see FIG. 9) with a first cutting member 34 (see FIG. 2b) of a printer cartridge cutting and removal device 10 (see FIG. 2B), such as printer cartridge cutting and removal device 10a.

As further shown in FIG. 8, the method 200 comprises step 204 of cutting a pair of second openings 86a, 86b in the printer cartridge 1 with a pair of second cutting members 28 (see FIG. 2B) of the printer cartridge cutting and removal device 10 (see FIG. 2B), and obtaining a cut-out portion 88 (see FIG. 2E) attached to the pair of second cutting members 86a, 86b. The first opening 84 is preferably positioned in between the pair of second openings 86a, 86b.

As further shown in FIG. 8, the method 200 comprises step 204 of removing the cut-out portion 88 from the printer cartridge 1 with the printer cartridge cutting and removal device 10.

FIG. 9 is a perspective view of a printer cartridge 1 for which the printer cartridge cutting and removal device 10 (see FIGS. 1A, 5A) of the disclosure may be used with or applied. As shown in FIG. 9, the printer cartridge 1 is preferably in the form of a remanufactured printer cartridge 2. As shown in FIG. 9, the printer cartridge 1, such as in the form of remanufactured printer cartridge 2, has a toner hopper 3, such as in the form of a remanufactured toner hopper 4. As further shown in FIG. 9, the printer cartridge 1, such as in the form of remanufactured printer cartridge 2, has a toner fill opening 5.

It can now be realized that embodiments of the disclosed devices and methods for remanufacturing a printer cartridge 1 (see FIG. 9) having a toner hopper 3 (see FIG. 9) configured to store toner, using one of the embodiments of a printer cartridge cutting and removal device 10 (see FIGS. 1A, 5A) of the disclosure have the advantage of facilitating cutting and removal of a toner fill opening without damage to the toner hopper or other components of the printer cartridge. This advantage is highly beneficial in the remanufacturing of printer cartridges, such as toner cartridges, as the appearance of the cartridge is preserved. It can further be realized that embodiments of the disclosed devices and methods provide for a novel tool and technique for efficiently cutting and removing a toner fill opening, which may be practiced when remanufacturing a previously used toner cartridge. The disclosed devices and methods cut and remove the toner fill opening without damage to other components of the printer cartridge.

### PARTS LIST

1: printer cartridge
2: remanufactured printer cartridge
3: toner hopper
4: remanufactured toner hopper
5: toner fill opening
10, 10a, 10b: printer cartridge cutting and removal device
12: sleeve member
14a, 14b: first end, second end
16: cylindrical body
18: threaded opening
20: threads
22: slotted portions
24: angled rim portion
26: second cutting member openings
28: second cutting members
30a, 30b: first end, second end
32a: angled cutting teeth
32b: insertion portion
34: first cutting member
36a: first cutting end
36b: second end
38: threaded drill bit
40: shaft opening
42: elongated shaft
44a, 44b: first end, second end
46: shaft body
46a: threaded portion
46b: unthreaded portion
48: threads
50: side openings
52: set elements (set screws)
54a: first portion
54b: slotted portion
56: collar member
58a, 58b: first end, second end
60: collar opening
62: side slots
64: drill attachment portion
66: drill attachment element
68: opening
70: first position
72: second position
74: spring support element
75: central opening
76a, 76b: first end, second end
78: toner hopper surface to be cut
78a: remanufactured toner hopper surface
80a: pre-cutting position
80b: initial cutting position
80c: full cutting position
80d: chamfering/cleaning position
80e: full removal position
80f: partial release position
80g: full release position
82: first rotational direction
84: first opening
86a, 86b: second openings
88: cut-out portion
90a, 90b: holding side portions
92: toner fill opening
94: upward direction
96: second rotational direction
100: downward direction
102: waste disposal element
104: guard member
106a, 106b: first end, second end
108a: first end opening
108b: second end opening
110: first body portion
111: second body portion
112: interior spaced portion
114: spring element
115a, 115b: first end, second end
116: angled face
120: attachment portion
124: washer
128: attachment element (screw)
130: first position
132: second position
134: downward position
136: upward position
138: downward position
140a: full cutting position
140b: full removal position
140c: partial release position
140d: full release position
200: method
202-206: method steps

Many modifications and other embodiments of the disclosure will come to mind to one skilled in the art to which this disclosure pertains having the benefit of the teachings presented in the foregoing descriptions and the associated drawings. The embodiments described herein are meant to be illustrative and are not intended to be limiting. Although specific terms are employed herein, they are used in a generic and descriptive sense only and for purposes of limitation. The invention is not limited in its application to the details of the construction and to the arrangement of the components set forth in the above description or as illustrated in the drawings.

What is claimed is:

1. A printer cartridge cutting and removal device for use in cutting an opening in a printer cartridge, the printer cartridge cutting and removal device comprising:
an elongated shaft;
a first cutting member attached to a first end of the elongated shaft;
a collar member attached to a second end of the elongated shaft;
a sleeve member having a threaded opening configured for attachment with a threaded portion on the first end of the elongate shaft; and,
a pair of second cutting members attached to a first end of the sleeve member;
wherein when the first cutting member and the second cutting members are configured to cut the opening comprising a toner fill opening in the printer cartridge.

2. The printer cartridge cutting and removal device of claim 1 further comprising a guard member having a first end opening and a second end opening that are configured for insertion of the sleeve member.

3. The printer cartridge cutting and removal device of claim 1 further comprising a spring element configured for insertion of the elongated shaft.

4. The printer cartridge cutting and removal device of claim 1 further comprising a spring support element having a central opening configured for insertion of the elongated shaft.

5. The printer cartridge cutting and removal device of claim 1 wherein the collar member comprises side slots, a drill attachment portion, and a drill attachment element.

6. A method for remanufacturing a printer cartridge having a toner hopper configured to store toner, the method comprising:
cutting a first opening in a printer cartridge with a first cutting member of a printer cartridge cutting and removal device;
cutting a pair of second openings in the printer cartridge with a pair of second cutting members of the printer cartridge cutting and removal device, the first opening being positioned in between the pair of second openings, and obtaining a cut-out portion attached to the pair of second cutting members; and,
removing the cut-out portion from the printer cartridge with the printer cartridge cutting and removal device.

7. The method of claim 6 wherein the printer cartridge cutting and removal device comprises:
an elongated shaft;
a first cutting member attached to a first end of the elongated shaft;
a collar member attached to a second end of the elongated shaft;
a sleeve member having a threaded opening configured for attachment with a threaded portion on the first end of the elongate shaft; and,
a pair of second cutting members attached to a first end of the sleeve member;
wherein when the first cutting member and the second cutting members are configured to cut the opening comprising a toner fill opening in the printer cartridge.
